(19) United States
(12) Patent Application Publication
(10) Pub. No.: US 2026/0023553 A1
(43) Pub. Date: Jan. 22, 2026

(54) ENFORCING STANDARDS WITH LARGE LANGUAGE MODELS

(71) Applicant: NVIDIA Corporation, Santa Clara, CA (US)

(72) Inventors: Niral Lalit PATHAK, Santa Clara, CA (US); Rajath Bellipady SHETTY, Sunnyvale, CA (US); Chandana NEERUKONDA, Fremont, CA (US); Ratin KUMAR, Santa Clara, CA (US)

(21) Appl. No.: 18/775,335

(22) Filed: Jul. 17, 2024

(51) Int. Cl. G06F 8/70

(52) U.S. Cl. CPC G06F 8/70

(57) ABSTRACT

In various examples, a technique for resolving a standards violation includes receiving a violation notification of a standards violation detected in a software codebase. The technique also includes determining additional information relevant to the standards violation and included in one or more information sources. The technique further includes generating a prompt based at least on the violation notification and the additional information, generating, using a machine learning model and based at least on the prompt, one or more corrective suggestions associated with the standards violation, and modifying the software codebase based at least on the one or more software code changes.

### BACKGROUND

When developing software code, software developers generally must adhere to one or more published standards. Standards may specify requirements, constraints, and/or best practices related to, e.g., formatting of computer code or other data, scripting languages, or programming languages. One or more governing bodies may also promulgate standards associated with particular industries or applications. For example, when developing automotive applications in general, or autonomous/semi-autonomous vehicle applications in particular, software developers may be required to adhere to relevant standards specific to the automotive industry (e.g., automotive safety integrity levels (ASIL) standards). Software developers may employ automated or semi-automated analysis tools to identify one or more standards violations in a software codebase. These analysis tools are generally limited to identifying standards violations in a software codebase and are not typically suitable for correcting standards violations except in the most trivial cases.

Conventionally, software developers correct identified standards violations based on a manual review of the identified violation(s) and a manual search of relevant information resources. Relevant information resources may include published documentation and/or examples associated with one or more governing standards, recorded discussions, messages, or other communication between developers that are relevant to the identified violation(s), portions of a software codebase stored in a software configuration management (SCM) system, or records of previously committed changes to the software codebase. These manual review and research techniques are time-consuming, error-prone, and are typically incomplete given the large volume of information contained in the relevant information resources. After review and research, software developers must manually revise the software codebase to correct the identified standards violation(s).

Other conventional techniques may employ a pre-trained large language model (LLM). Software developers may query an LLM with a prompt that includes an identified standards violation, a section of software code related to the violation, and a request for corrective suggestions. An LLM that has been pre-trained on a broad corpus of training data may not include sufficiently detailed information relevant to a specific violation to generate a useful corrective suggestion. Techniques that augment an LLM prompt with a large volume of domain-specific information, such as an entire software codebase or the entirety of published documentation and/or examples related to a standard, may not be computationally performant to generate corrective suggestions within an acceptable response time.

As such, a need exists for more effective techniques for enforcing standards in computer code.

### SUMMARY

Embodiments of the present disclosure relate to enforcing standards with large language models. The techniques described herein include retrieving contextual information relevant to a standards violation identified in a software codebase. The disclosed techniques retrieve the contextual information from one or more information sources and augment one or more large language model (LLM) prompts with the relevant contextual information to cause the LLM to generate suggestions for correcting the standards violation. The techniques further include incorporating the suggestions into changes to a software codebase.

In contrast to conventional systems, the disclosed techniques automatically retrieve contextual information related to an identified standards violation. The disclosed techniques identify a standards violation and a portion of a codebase that includes the standards violation via, e.g., a static analysis tool. The disclosed techniques compare the identified violation and/or the portion of the codebase to the contents of one or more information sources. The one or more information sources may include published documentation and/or examples related to a governing standard, recordings of discussions, messages, or other communications between developers, a software codebase, and/or previously committed changes to the software codebase. The contents of the one or more information sources may be stored as entries in, e.g., one or more vector databases to facilitate comparison to vector representations of the identified violation and/or the portion of the codebase containing the violation.

The disclosed techniques generate an LLM prompt that includes the identified violation and a portion of the codebase containing the violation. The disclosed techniques further augment the LLM prompt with relevant information retrieved from the one or more information sources. In response to the augmented prompt, the LLM may generate a natural language explanation of the identified standards violation and/or one or more suggestions to correct the identified standards violation. The disclosed techniques may further prompt the LLM to generate a difference file representing proposed changes to the software codebase, where the proposed changes implement the corrective suggestions generated by the LLM. The disclosed techniques may apply the difference file to the software codebase and commit the changed software codebase to, e.g., a software configuration management (SCM) system. The disclosed techniques automatically generate relevant, actionable suggestions to correct standards violations without pre-training an LLM on a large quantity of domain-specific data or requiring manual review of multiple information sources by a developer.

### BRIEF DESCRIPTION OF THE DRAWINGS

The present systems and methods for enforcing standards with large language models are described in detail below with reference to the attached drawing figures, wherein:

FIG. 1 is a block diagram of an example computing device suitable for use in implementing some embodiments of the present disclosure;

FIG. 2 is an illustration of data flow between various components, according to some embodiments of the present disclosure;

FIG. 3 is a more detailed illustration of the resolution engine of FIG. 1, according to various embodiments;

FIG. 4 illustrates a flow diagram of a method for resolving a standards violation, according to various embodiments;

FIG. 5 is a block diagram of an example computing device suitable for use in implementing some embodiments of the present disclosure; and

FIG. 6 is a block diagram of an example data center suitable for use in implementing some embodiments of the present disclosure.

FIG. 7A is a block diagram of an example generative language model system suitable for use in implementing at least some embodiments of the present disclosure.

FIG. 7B is a block diagram of an example implementation in which the generative language model LM 730 of FIG. 7A includes a transformer encoder-decoder.

FIG. 7C is a block diagram of an example implementation in which the generative language model LM 730 of FIG. 7A includes a decoder-only transformer architecture.

### DETAILED DESCRIPTION

Systems and methods are disclosed related to enforcing standards with large language models. Although the present disclosure may be described with respect to identifying and correcting violations of industry-specific standards, such as standards governing software developed for automotive applications or autonomous/semi-autonomous driving applications, this is not intended to be limiting. For example, the systems and methods described herein may be used, without limitation, to identify and correct standards violations related to syntax, formatting standards, scripting languages, or programming languages related to any industry, such as medicine, aviation, or power generation. In addition, although the use of LLMs is primarily described, this is not intended to be limiting, and other model types may be used-such as vision language models (VLMs), multi-modal language models, transformer models, etc.—without departing from the scope of the present disclosure.

As discussed herein, conventional techniques may require that a software developer manually review identified standards violation(s) in a software codebase and conduct a manual search of multiple resources to find information relevant to the identified violation(s). Conventional techniques may further require that the software developer interpret the relevant information and manually modify the software codebase to correct the violation(s). These techniques are time-consuming, error-prone, and unlikely to result in a comprehensive search of available resources. Other conventional techniques may augment a large language model (LLM) prompt with large quantities of relevant and non-relevant domain-specific information. These conventional techniques are not computationally performant to generate corrective suggestions for a standards violation within an acceptable response time.

To improve the identification and correction of standards violations, the disclosed techniques retrieve information relevant to an identified standards violation. The disclosed techniques may retrieve relevant information from multiple information sources, such as a software developer's codebase, previously committed changes to the developer's codebase, historical conversations or other discussions between developers, documentation associated with one or more industry standards, and/or other sources. Based on the identified standards violation and the retrieved information, the disclosed techniques generated an augmented prompt for a large language model (LLM). The LLM generates a natural language explanation of the identified standards violation and identifies one or more corrective actions addressing the identified standards violation. The techniques may generate an additional LLM prompt requesting the generation of a difference file that, when applied to a software codebase that includes the standards violation, generates a modified codebase in which the standards violation has been corrected. The disclosed techniques are operable to identify and correct violations of different standards, such as coding standards, formatting standards, or industry-specific standards. In addition to identifying and correcting violations of different standards, the disclosed techniques are operable to detect and suggest corrections for security risks, software vulnerabilities, or software compliance issues, e.g., missing or outdated software licenses. In these use cases, the static analysis tool described below may be replaced or augmented with one or more analysis tools suitable for identifying security risks, software vulnerabilities, or software compliance issues.

A resolution engine may include a static analysis tool that analyzes a software codebase and may identify a standards violation included in the codebase. The static analysis tool generates a notification of the identified standards violation, where the notification may include a natural language description of the standards violation, a numeric or alphanumeric identifier associated with the standards violation, a standard associated with the standards violation, and/or a portion of code included in the codebase and associated with the identified standards violation.

The resolution engine receives the generated notification of the identified standards violation from the static analysis tool and generates one or more vector representations based on textual, semantic, or other features included in the notification. The resolution engine may retrieve relevant information from one or more information sources based on at least the vector representations, as described herein.

The resolution engine may retrieve, e.g., via a language server protocol request and based on the portion of code included in the notification, portions of the software codebase that are relevant to the identified standards violation. The retrieved portions may include variables, data structures, and/or algorithms relevant to a portion of code included in the notification.

The resolution engine may retrieve all or a portion of one or more previously committed code changes from a commit database that includes previously committed code changes, where the one or more previously committed code changes are relevant to the identified standards violation. The commit database may include plaintext representations of the previously committed code changes and/or vector representations of the previously committed code changes. The resolution engine may retrieve the relevant previously committed code changes based on textual similarities between the contents of the violation notification and the contents of the database of previously committed code changes. Additionally or alternatively, the resolution engine may retrieve the relevant previously committed code changes based on one or more vector similarities between vector representations of the standards violation notification and the vector representations included in the database of previously committed code changes.

The resolution engine may retrieve all or portions of one or more relevant archived conversations between software developers. For example, an archived conversation may include a discussion relevant to a standards violation included in the standards violation notification. The resolution engine may generate vector representations of the one or more archived conversations and store the generated vector representations in a conversation database. The resolution engine may retrieve the relevant archived conversation(s) based on one or more vector similarities between vector representations associated with the standards violation notification and the vectors included in the conversation database.

The resolution engine may retrieve relevant portions of documentation associated with one or more standards. The standards may include organizational standards, industry-specific standards, formatting standards, and/or standards associated with a particular programming environment. The documentation may include listings of standards violations, numeric and/or alphanumeric codes associated with the standards violations, natural language descriptions of the standards violations, or example code segments associated with the standards violations. The resolution engine may generate vector representations based on the documentation and store the vector representations in a documentation database. The resolution engine may retrieve the relevant portions of the documentation based on one or more vector similarities between vector representations associated with the standards violation notification and the vectors included in the documentation database. The resolution engine queries the software codebase, commit database, conversation database, and/or the documentation database automatically, obviating the need for a manual human review of multiple sources for information relevant to an identified standards violation.

The resolution engine generates a prompt for a large language model (LLM). The prompt may include information included in the standards violation notification as described herein. The resolution engine may augment the generated prompt based on relevant information retrieved from the software codebase, commit database, conversation database, and/or the documentation database.

Based on the prompt, the LLM generates a natural language explanation of the identified standards violation, as well as suggestions to correct the standards violation. The resolution engine may generate a further prompt instructing the LLM to generate a difference file that, when applied to the software codebase that includes the standards violation, generates a modified codebase in which the standards violation has been corrected. The resolution engine may, upon optional confirmation or direction, apply the difference file to the software codebase and store the modified codebase. The disclosed techniques do not require training the LLM on a training corpus of domain-specific knowledge, and are operable to resolve a standards violation without manual modification of a software codebase.

The disclosed techniques are operable to identify and correct standards violations in software codebases associated with various technologies. For example, the disclosed techniques may identify and correct standards violations in one or more automotive software codebases configured to perform perception, planning, navigation, control, or actuation for an autonomous or semi-autonomous vehicle. In the field of robotic technology, the disclosed techniques may identify and correct standards violations in one or more software codebases configured to provide positional awareness, actuation, motion or path planning, or sensory feedback analysis in a robotic system. The industrial and technological fields described above are non-limiting, and the disclosed techniques may also identify and correct standards violations in software codebases included in applications directed to a variety of other industries and/or technologies, such as smart factories, medical simulation and/or visualization, energy production, reservoir simulation, cyber security, and/or financial analysis.

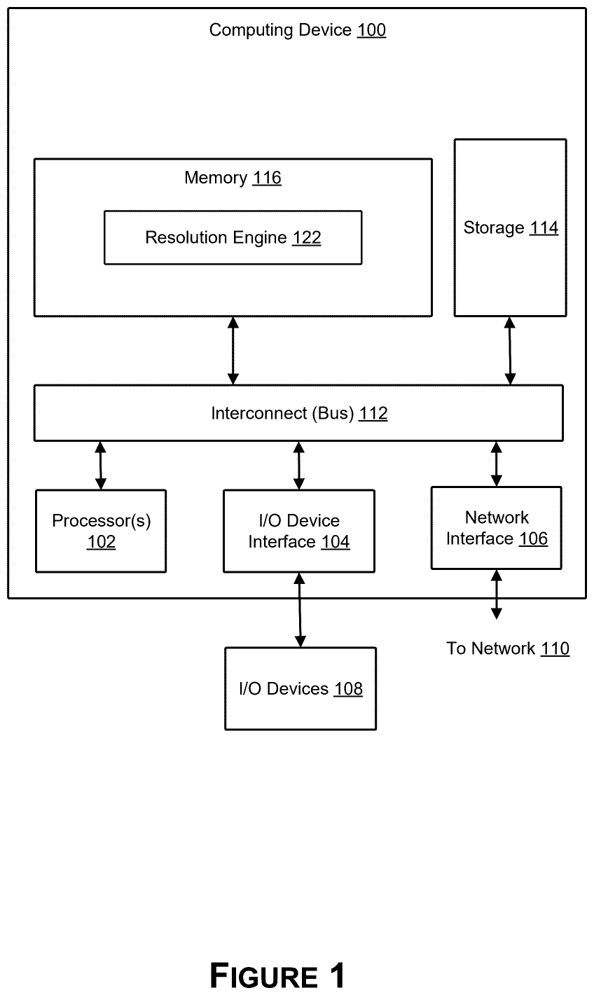

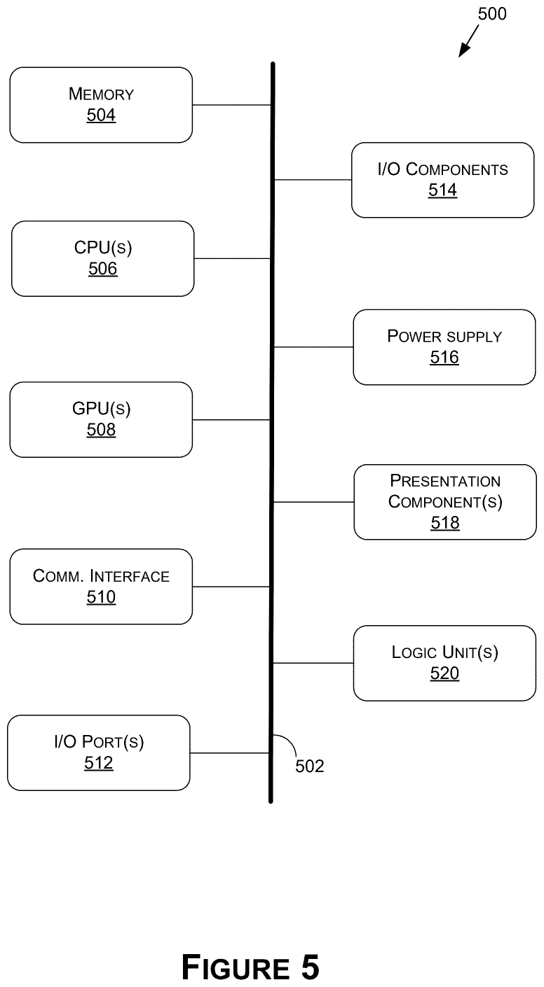

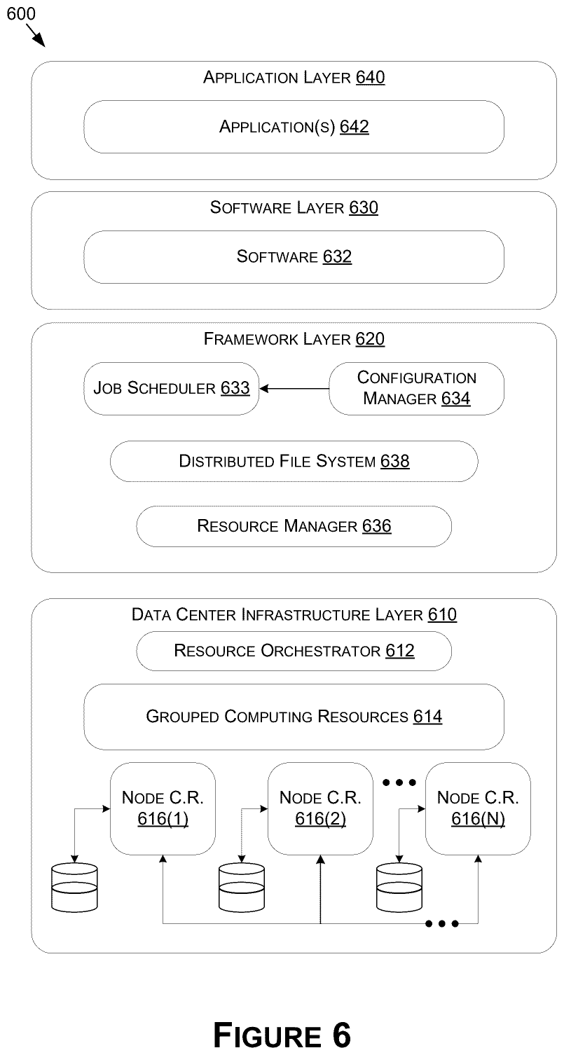

FIG. 1 illustrates a block diagram of an example computing device in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 500 of FIG. 5, and/or example data center 600 of FIG. 6.

In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a resolution engine 122 that resides in a memory 116.

It is noted that the computing device described herein is illustrative and that any other technically feasible configurations fall within the scope of the present disclosure. For example, multiple instances of resolution engine 122 could execute on a set of nodes in a distributed and/or cloud computing system to implement the functionality of computing device 100. In another example, resolution engine 122 could execute on various sets of hardware, types of devices, or environments to adapt resolution engine 122 to different use cases or applications. In a third example, resolution engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Resolution engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including resolution engine 122.

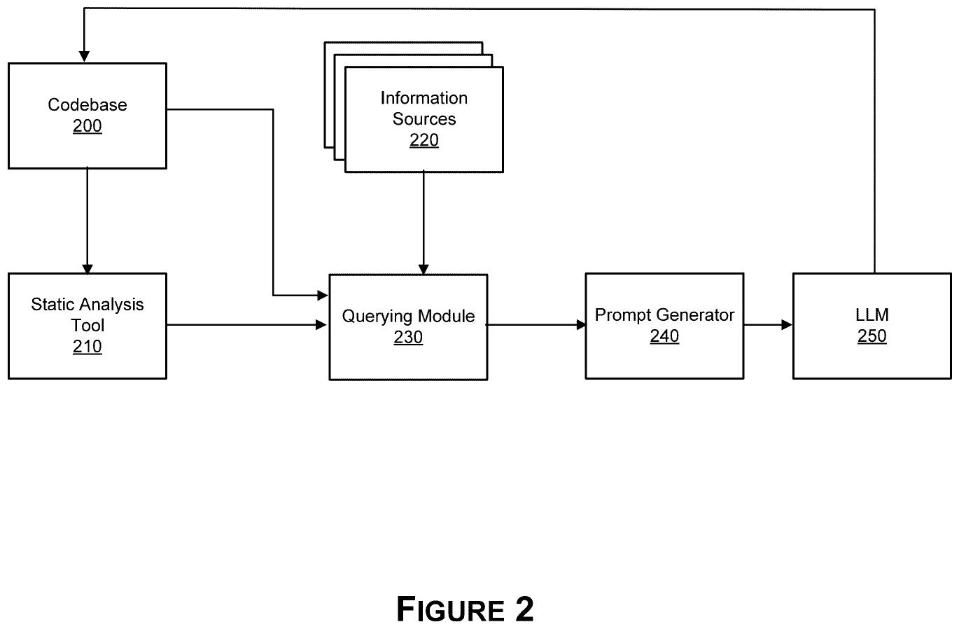

FIG. 2 is an illustration of data flow between various components, according to some embodiments of the present disclosure. The various components include, without limitation, a codebase 200, a static analysis tool 210, information sources 220, querying module 230, prompt generator 240, and large language model (LLM) 250.

Codebase 200 may include computer source code associated with a software program, component, or system. In various embodiments, codebase 200 may reside within a source code management (SCM) system. Codebase 200 may be stored locally, remotely within an enterprise computing environment, or in a cloud storage system.

Static analysis tool 210 receives all or a portion of the contents of codebase 200 and analyzes the contents to detect a violation of one or more standards. The standards represent one or more requirements, specifications, guidelines, or characteristics, and may include organizational standards, industry-specific standards, formatting standards, and/or standards associated with a particular programming environment. The static analysis tool generates a notification of an identified standards violation, where the notification may include a natural language description of the standards violation, a numeric or alphanumeric identifier associated with the standards violation, a standard associated with the standards violation, and/or a portion of code included in codebase 200 and associated with the identified standards violation. Static analysis tool 210 transmits the generated violation notification to querying module 230.

Querying module 230 determines information relevant to the identified standards violation based on the information included in the generated violation notification received from static analysis tool 210. Querying module 230 may identify and retrieve relevant information included in codebase 200 and/or one or more of information sources 220. Querying module 230 may determine, via a language server protocol request and based on the portion of code included in the violation notification, portions of the software codebase that are relevant to the identified standards violation. The portions may include variables, data structures, and/or algorithms relevant to a portion of code included in the notification.

Querying module 230 may determine and retrieve one or more previously committed code changes that are included in a commit database included in information sources 220 and that are relevant to the identified standards violation. The commit database may include plaintext representations of the previously committed code changes. A vector database may include vector representations of the previously committed code changes. Querying module 230 may determine previously committed code changes that are relevant to the standards violation based on textual similarities between the contents of the standards violation notification and the contents of the database of previously committed code changes. Additionally or alternatively, querying module 230 may determine the relevant previously committed code changes based on one or more vector similarities between vector representations of the standards violation notification and vector representations of information included in the commit database.

Querying module 230 may determine all or portions of one or more relevant archived conversations between software developers included in information sources 220. For example, an archived conversation may include a discussion relevant to a standards violation included in the standards violation notification. Querying module 230 may retrieve the relevant archived conversation(s) based on one or more vector similarities between vector representations associated with the standards violation notification and vectors included in a vector database generated based on the conversation database.

Querying module 230 may determine relevant portions of documentation associated with one or more standards included in information sources 220. The standards may include organizational standards, industry-specific standards, formatting standards, and/or standards associated with a particular programming environment. The documentation may include listings of standards violations, numeric and/or alphanumeric codes associated with the standards violations, natural language descriptions of the standards violations, or example code segments associated with the standards violations. Querying module 230 may retrieve the relevant portions of documentation based on one or more vector similarities between vector representations associated with the standards violation notification and vectors included in a vector database generated based on the documentation database.

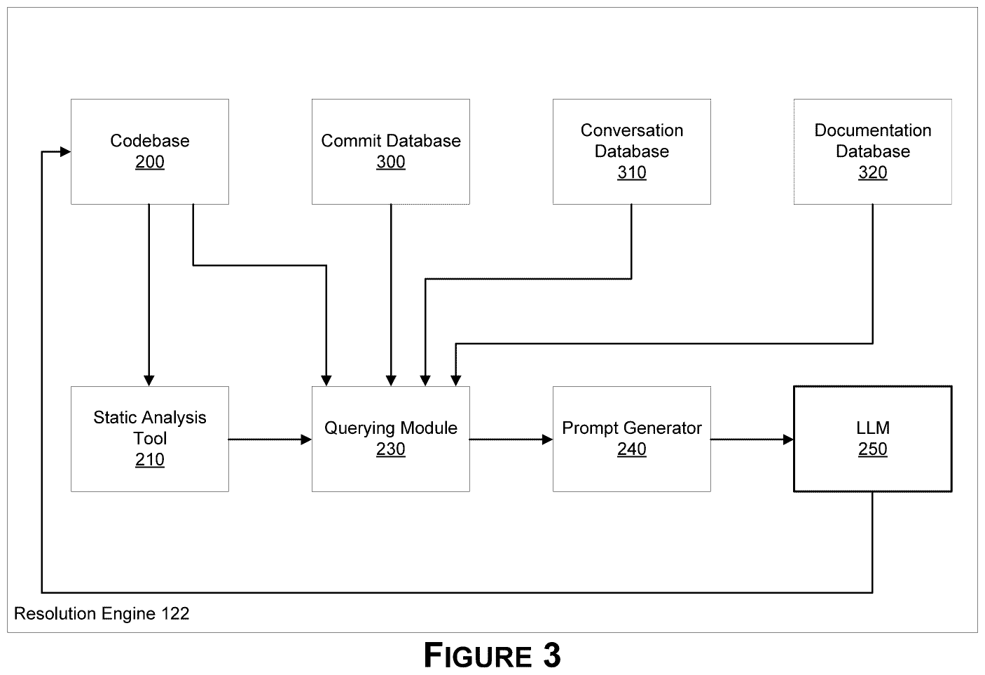

Querying module 230 queries information sources 220 automatically and retrieves relevant information, obviating the need for a manual human review of multiple sources for information relevant to an identified standards violation. Querying module 230 and various databases included in information sources 220 are discussed in greater detail in the description of FIG. 3 below. Querying module 230 transmits the identified standards violation and the information retrieved from codebase 200 and information sources 220 to prompt generator 240.

Prompt generator 240 generates an augmented prompt for LLM 250. In various embodiments, the augmented prompt includes the violation notification received from static analysis tool 210 and the relevant information retrieved from codebase 200 and/or information sources 220. The augmented prompt may also include a natural language prompt requesting that LLM 250 provide an explanation for a violation included in the violation notification, as well as a request for LLM 250 to provide corrective suggestions for resolving the violation. Prompt generator 240 may also generate a prompt requesting that LLM 250 generate a collection of one or more changes that, when applied to the codebase, correct the standards violation identified in the violation notification. Prompt generator 240 transmits the generated prompt(s) to LLM 250.

LLM 250 includes a large language model, a vision language model, a multi-modal language model, and/or another type of model. In various embodiments, LLM 250 may be pre-trained based solely on a large corpus of general training data. In other embodiments, LLM 250 may be further fine-tuned on training data relevant to one or more particular topics, enterprises, industries, use cases, and/or programming environments. For example, LLM 250 may be fine-tuned on training data that includes violation-code pairs, where each violation-code pair includes a previously identified standards violation and associated software code changes that correct the standards violation. Based on the prompt(s) received from prompt generator 240, LLM 250 may generate a natural language explanation associated with a standards violation included in the prompt(s). LLM 250 may also generate one or more suggestions for resolving the standards violation. LLM 250 may further generate a set of software code changes that, when applied to a codebase that includes the standards violation, resolve the standards violation. Upon direction from and/or approval by a user, the disclosed techniques may apply the software code changes and commit the changed software code to, e.g., codebase 200.

FIG. 3 is a more detailed illustration of resolution engine 122 of FIG. 1, according to various embodiments. Resolution engine 122 detects a standards violation in a computer software codebase, retrieves relevant information associated with the standards violation and, via a large language model (LLM), generates a natural language explanation for the standards violation and corrective suggestions. Resolution engine 122 may generate suggested software code changes and apply the changes to the software codebase. Resolution engine 122 includes, without limitation, codebase 200, static analysis tool 210, querying module 230, prompt generator 240, and LLM 250, as described above in the description of FIG. 2. Resolution engine 122 further includes, without limitation, commit database 300, conversation database 310, and documentation database 320. Commit database 300, conversation database 310, and documentation database 320 represent examples of information sources 220 discussed above in the description of FIG. 2.

As discussed above, codebase 200 may include computer code associated with a software program, component, or system. Codebase 200 may also include other types of formatted content, such as scripted instructions, HTML, XML, or JSON. In various embodiments, codebase 200 may reside within a source code management (SCM) system. Codebase 200 may be stored locally within resolution engine 122, remotely within an enterprise computing environment, or in a cloud storage system.

Static analysis tool 210 analyzes all or a portion of the contents of codebase 200 and analyzes the contents to detect a violation of one or more standards. In various embodiments, the standards may include, e.g., organizational standards, industry standards, standards associated with a programming language, formatting language, a programming environment, and/or other standard types. Static analysis tool 210 generates a notification of an identified standards violation, where the violation notification may include a natural language description of the standards violation, a numeric or alphanumeric identifier associated with the standards violation, a standard associated with the standards violation, and/or a portion of code included in the codebase and associated with the identified standards violation. Static analysis tool 210 transmits the generated violation notification to querying module 230.

Querying module 230 receives the generated violation notification from static analysis tool 210 and identifies relevant information included in one or more of information sources 220, such as codebase 200, commit database 300, conversation database 310, or documentation database 320. Various embodiments may include additional or alternative examples of information sources 220.

Querying module 230 may query codebase 200 via a language server protocol request, where the request includes one or more portions of codebase 200 included in the violation notification received from static analysis tool 210. The results of the language server protocol request may include code snippets, variables, or data structures included in codebase 200 that are relevant to the identified standards violation included in the violation notification. Querying module 230 stores the retrieved language server protocol request results for transmission to prompt generator 240 described below.

Based on the violation notification received from static analysis tool 210, querying module 230 may query commit database 300 to determine all or a portion of one or more previously committed changes to a software codebase that are relevant to the identified standards violation included in the violation notification. In various embodiments, querying module 230 may query commit database 300 based on textual similarities between portions of codebase 200 included in the violation notification and the contents of commit database 300. Additionally or alternatively, resolution engine 122 may generate a commit vector database (not shown) that includes a plurality of commit feature vectors based on textual and/or semantic features included in commit database 300. Querying module 230 may generate one or more violation feature vectors based on the contents of the violation notification and query the commit vector database based on the one or more violation feature vectors. In some embodiments, querying module 230 may compare the one or more violation feature vectors with the contents of the commit vector database via a vector distance calculation, such as a cosine difference calculation. Querying module 230 stores the retrieved query results from commit database 300 for transmission to prompt generator 240.

Based on the violation notification received from static analysis tool 210, querying module 230 may determine and retrieve portions of historical conversations included in conversation database 310 that are relevant to the violation notification. Conversation database 310 may include historical records of chat conversations between software developers, messages exchanged between software developers, and/or posts included in one or more discussion forums. In various embodiments, resolution engine 122 extracts one or more chats, conversations, or posts from conversation database 310. Resolution engine 122 generates one or more conversation feature vectors based on textual and/or semantic features included in the one or more chats, conversations, or posts, and generates a conversation vector database (not shown) that includes the one or more conversation feature vectors. Querying module 230 may generate one or more violation feature vectors based on the contents of the violation notification and query the conversation vector database based on the one or more violation feature vectors. Querying module 230 determines one or more relevant portions of conversation database 310 based on a vector comparison of the violation feature vectors and the contents of the conversation vector database. Querying module 230 stores the retrieved query results from conversation database 310 for transmission to prompt generator 240.

Based on the violation notification received from static analysis tool 210, querying module 230 may query documentation database 320 and determine all or portions of documentation relevant to the violation notification. In various embodiments, documentation database 320 may include published documentation relevant to one or more organizational, industry, or programming standards, such as rules stored in Portable Document Format (PDF) documents, example code snippets, or natural language descriptions associated with one or more standards violations. Resolution engine 122 generates one or more documentation feature vectors based on textual and/or semantic features included in documentation database 320, and generates a documentation vector database (not shown) that includes the one or more documentation feature vectors. Querying module 230 may generate one or more violation feature vectors based on the contents of the violation notification and query the documentation vector database based on the one or more violation feature vectors. Querying module 230 determines one or more relevant portions of documentation database 320 based on a vector comparison of the violation feature vectors and the contents of the documentation vector database. Querying module 230 stores the retrieved query results from documentation database 320 for transmission to prompt generator 240.

Resolution engine 122 generates one or more prompts for large language model (LLM) 250 via prompt generator 240. In various embodiments, a prompt may include a natural language request for LLM 250 to provide an explanation and corrective suggestions related to a standards violation. Resolution engine 122 may also augment the prompt to include the contents of the violation notification and relevant information retrieved from codebase 200, commit database 300, conversation database 310, and/or documentation database 320 as described above. Resolution engine 122 may generate an additional prompt via prompt generator 240 requesting that LLM 250 generate a difference file containing changes that, when applied to codebase 200, resolve the standards violation associated with the violation notification.

LLM 250 includes a large language model, a vision language model (VLM), a multi-modal language model, and/or another model type. In various embodiments, LLM 250 is pre-trained on a corpus of general training data, without further training or fine-tuning. In other embodiments, resolution engine 122 may fine-tune LLM 250 on a training corpus including domain-specific information. For example, LLM 250 may be fine-tuned on training data that includes violation-code pairs, where each violation-code pair includes a previously identified standards violation and associated software code changes that correct the standards violation. In response to one or more prompts received from prompt generator 240, LLM 250 may generate a natural language explanation for a standards violation based on the violation notification and/or any additional relevant information retrieved from codebase 200, commit database 300, conversation database 310, and/or documentation database 320. The natural language explanation may include a standard associated with the violation, an alphanumeric code or other identifier associated with the violation, a description of the violation, and one or more portions of code included in the LLM prompt. LLM 250 may also generate one or more corrective suggestions related to the standards violation. The corrective suggestions may include a natural language explanation of the standard and/or violation, as well as suggested modifications to codebase 200. As described above, LLM 250 may also generate a difference file containing changes that, when applied to codebase 200, resolve the standards violation associated with the violation notification. In various embodiments, resolution engine 122 may automatically apply the difference file and commit the resulting changes to codebase 200. Alternatively, resolution engine 122 may apply the difference file to codebase 200 and commit the resulting changes upon direction and/or authorization from a user.

In some embodiments, such as where the code is associated with visualizations, the LLM 250 may process visualizations generated based on outputs of the code and/or may generate visualizations illustrating issues or errors that are generated as a result of the code. In some examples, the output of the LLM 250 may further include a visualization after the code is corrected. For example, the LLM 250 may first generate an output that indicates a visualization associated with error or violation, and then may generate an output that indicates a visualization associated with the correction, for comparison. For example, where the code is associated with a perception output of a robot or autonomous vehicle—such as an output indicating a location of lane lines within an image—the visualizations may include overlays of predicted lane locations on the corresponding images. As such, the initial code error visualization may indicate lane estimations that are inaccurate, or completely wrong, while the updated code visualization may indicate a more accurate prediction of lane locations. This same concept can apply to any technology space where outputs may be represented visually.

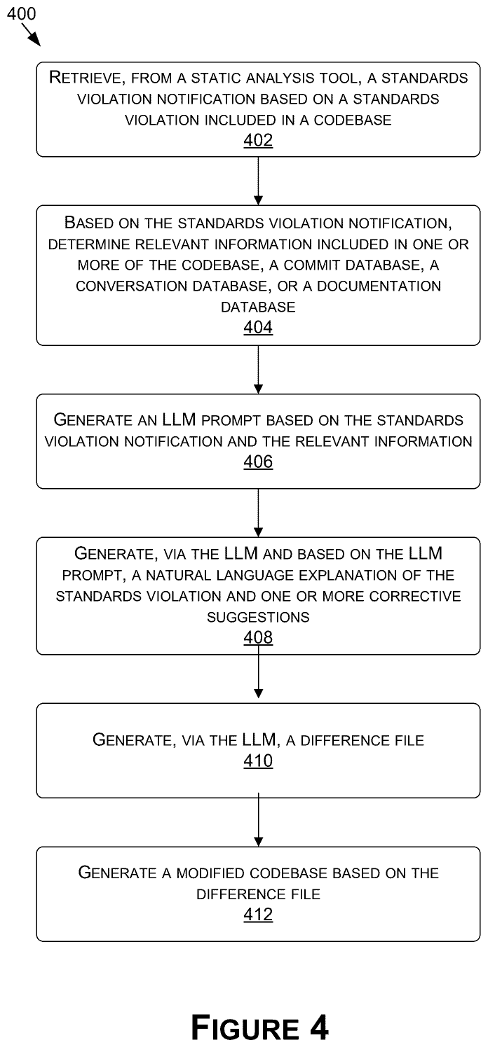

Now referring to FIG. 4, each block of method 400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to the systems of FIGS. 2 and 3. However, these methods may additionally or alternatively be executed by any one system, or any combination of systems, including, but not limited to, those described herein.

FIG. 4 is a flow diagram showing a method 400 for resolving a standards violation, in accordance with some embodiments of the present disclosure. As shown in FIG. 4, method 400 begins with operation 402, in which resolution engine 122 receives a violation notification from static analysis tool 210. The violation notification may include a natural language description of a standards violation identified in codebase 200, a numeric or alphanumeric identifier associated with the standards violation, a standard associated with the standards violation, and/or a portion of code included in codebase 200 and associated with the identified standards violation.

In operation 404, resolution engine 122 determines, via querying module 230, information relevant to the identified standards violation and included one or more of codebase 200, commit database 300, conversation database 310, or documentation database 320. In various embodiments, querying module 230 may retrieve relevant information based on textual similarities between the violation notification and the contents of one or more of codebase 200, commit database 300, conversation database 310, or documentation database 320. Additionally or alternatively, resolution engine 122 may generate one or more vector databases containing feature vectors based on textual and/or semantic features included in codebase 200, commit database 300, conversation database 310, or documentation database 320. Querying module 230 may generate a feature vector based on textual or semantic features included in the violation notification and determine relevant information based on a vector comparison between the generated feature vector and the contents of the one or more vector databases.

In operation 406, resolution engine 122 generates, via prompt generator 240, a prompt for a large language model (LLM) based on the violation notification and the retrieved relevant information. The prompt may include a request for the LLM to generate a natural language explanation associated with a standards violation included in the violation notification. The prompt may also include a request for the LLM to generate one or more corrective suggestions related to the standards violation. Resolution engine 122 may augment the prompt with relevant information gathered by querying module 230 from one or more of codebase 200, commit database 300, conversation database 310, or documentation database 320. Resolution engine 122 may further generate a prompt via prompt generator 240 requesting that the LLM generate a difference file containing changes that, when applied to codebase 200, correct the standards violation included in the violation notification.

In operation 408, resolution engine 122 generates, via LLM 250 and based on the prompt, a natural language explanation of the standards violation included in the violation notification. The natural language explanation may include one or more code segments included in codebase 200 and associated with the standards violation. The natural language explanation may further include a standard associated with the standards violation, an alphanumeric code associated with the standards violation, or a description of the standards violation. LLM 250 may further generate one or more corrective suggestions associated with the standards violation.

In operation 410, LLM 250 may, in response to a prompt generated by prompt generator 240, generate a difference file associated with codebase 200 and the standards violation. The difference file includes one or more software changes that, when applied to codebase 200, correct the identified standards violation.

In operation 412, resolution engine 122 applies the difference file to codebase 200 to generate a modified codebase. In various embodiments, resolution engine 122 may apply the difference file to codebase 200 automatically. In other embodiments, resolution engine 122 may apply the difference file to codebase 200 upon the direction of, and/or with the permission of, a human user. After applying the difference file to codebase 200, resolution engine 122 may commit the modified codebase to codebase 200.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as large language models (LLMs), vision language models (VLMs), multi-modal language models, etc., systems for performing light transport simulation, systems for performing collaborative content creation for 3D assets, systems implemented at least partially using cloud computing resources, and/or other types of systems.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 633, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 633 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 633. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

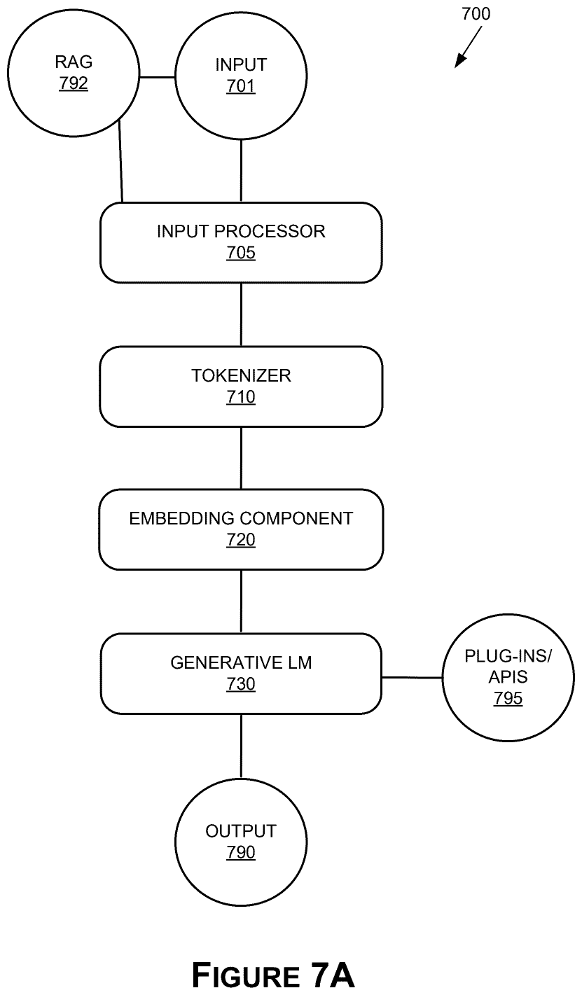

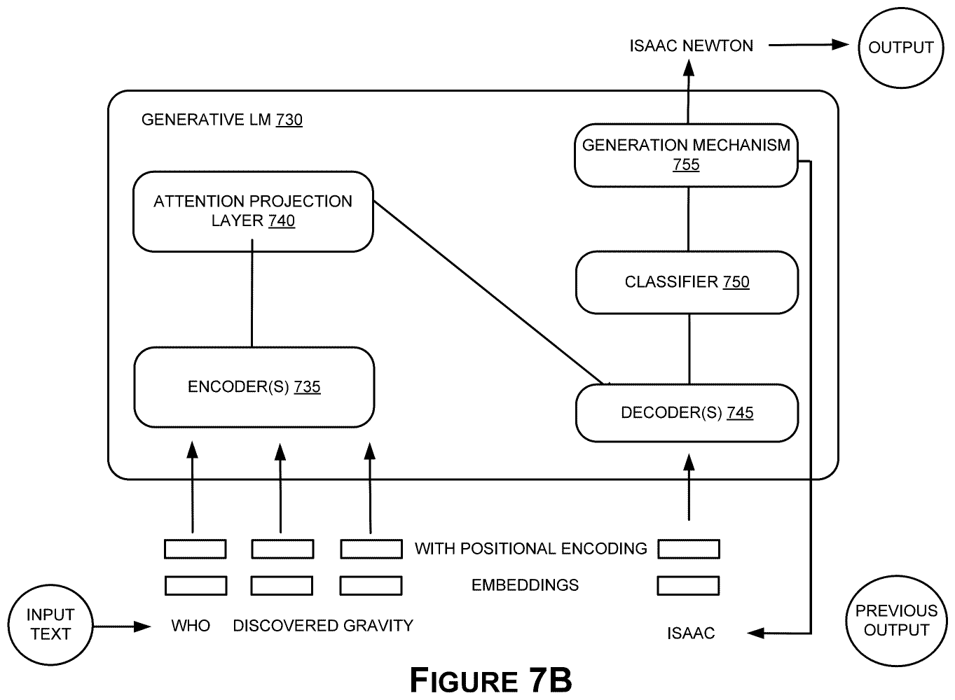

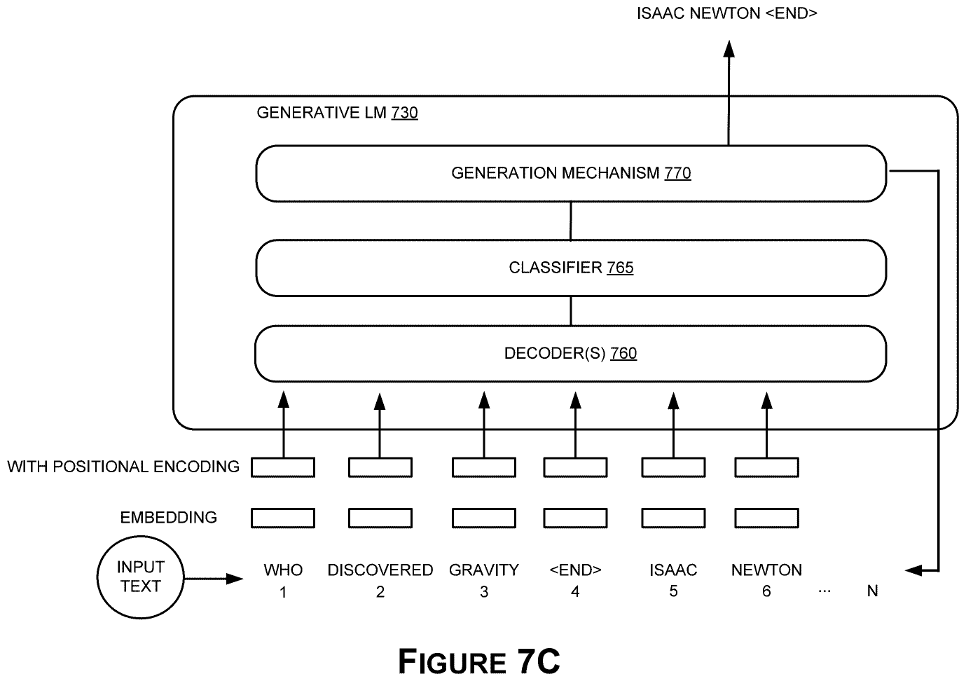

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a multi-modal LM, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 730. In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multimodal inputs, the input 701 may combine text with image data, audio data, and/or other types of input data, such as but not limited to those described herein. Taking raw input text as an example, the input processor 705 may prepare raw input text in various ways. For example, the input processor 705 may perform various types of text cleaning to remove noise (e.g., special characters, punctuation, HTML tags, stopwords) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 may be used to retrieve additional information to be used as part of the input 701 or prompt. For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The tokenizer 710 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data, the input processor 701 may resize the image data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features—such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multimodal data, the embedding component 720 may fuse representations of the different types of data (e.g., text, image, audio) using techniques like early fusion (concatenation), late fusion (sequential processing), attention-based fusion, etc.

The generative LM 730 and/or other components of the generative LLM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 97A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A computer-implemented method comprising:
receiving a violation notification of a standards violation detected in a software codebase;
determining additional information relevant to the standards violation and included in one or more information sources;
generating a prompt based at least on the violation notification and the additional information;
generating, using a machine learning model and based at least on the prompt, one or more corrective suggestions associated with the standards violation; and
modifying the software codebase based at least on the one or more software code changes.

2. The computer-implemented method of claim 1, wherein the one or more information sources include at least one of the software codebase, a commit database, a conversation database, or a documentation database.

3. The computer-implemented method of claim 1, further comprising generating, using the machine learning model and based on at least the prompt, at least one of a natural language explanation associated with the standards violation or a visualization indicating the standards violation visually.

4. The computer-implemented method of claim 1, further comprising generating, using the machine learning model and based at least on the prompt, a difference file including software changes that, when applied to the software codebase, correct the standards violation.

5. The computer-implemented method of claim 4, wherein the modifying the software codebase further comprises:
applying the difference file to the software codebase to generate a modified software codebase; and
storing the modified software codebase.

6. The computer-implemented method of claim 1, wherein the retrieving the additional information is based on textual similarities between the violation notification and the contents of one or more of the information resources.

7. The computer-implemented method of claim 1, wherein the retrieving the additional information further comprises:
generating a feature vector based on one or more textual or semantic features included in the violation notification;
generating one or more vector databases based on textual or semantic features included in the one or more information sources; and
calculating a vector distance based on the feature vector and the contents of the one or more vector databases.

8. The computer-implemented method of claim 1, wherein the machine learning model includes a large language model, a vision language model, or a multi-modal language model.

9. A system comprising:
one or more processors to execute operations comprising:
receiving a violation notification of a standards violation detected in a software codebase;
determining additional information relevant to the standards violation and included in one or more information sources;
generating a prompt based at least on the violation notification and the additional information;
generating, using a machine learning model and based at least on the prompt, one or more corrective suggestions associated with the standards violation; and
modifying the software codebase based at least on the one or more software code changes.

10. The system of claim 9, wherein the one or more information sources include at least one of the software codebase, a commit database, a conversation database, or a documentation database.

11. The system of claim 9, wherein the operations further comprise generating, using the machine learning model and based on at least the prompt, a natural language explanation associated with the standards violation.

12. The system of claim 9, wherein the operations further comprise generating, using the machine learning model and based at least on the prompt, a difference file including software changes that, when applied to the software codebase, correct the standards violation.

13. The system of claim 12, wherein the modifying the software codebase further comprises:
applying the difference file to the software codebase to generate a modified software codebase; and
storing the modified software codebase.

14. The system of claim 9, wherein the determining the additional information is based on textual similarities between the violation notification and the contents of one or more of the information resources.

15. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

16. At least one processor comprising:
one or more circuits to:
receive a violation notification of a standards violation detected in a software codebase;
determine additional information relevant to the standards violation and included in one or more information sources;
generate a prompt based at least on the violation notification and the additional information;
generate, using a machine learning model and based at least on the prompt, one or more corrective suggestions associated with the standards violation; and
modify the software codebase based at least on the one or more software code changes.

17. The at least one processor of claim 16, wherein the one or more circuits further generate, using the machine learning model and based on at least the prompt, a natural language explanation associated with the standards violation.

18. The at least one processor of claim 16, wherein the one or more circuits further generate, using the machine learning model and based at least on the prompt, a difference file including software changes that, when applied to the software codebase, correct the standards violation.

19. The at least one processor of claim 16, wherein the determining the additional information is based on textual similarities between the violation notification and the contents of one or more of the information resources.

20. The at least one processor of claim 16, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.
